(19) United States
(12) Patent Application Publication
(10) Pub. No.: US 2022/0382800 A1
(43) Pub. Date: Dec. 1, 2022

(54) CONTENT-BASED MULTIMEDIA RETRIEVAL WITH ATTENTION-ENABLED LOCAL FOCUS

(71) Applicant: Microsoft Technology Licensing, LLC, Redmond, WA (US)

(72) Inventors: Robin ABRAHAM, Redmond, WA (US); Neda ROHANI, Bellevue, WA (US); Rohith Venkata PESALA, Frisco, TX (US); J Brandon SMOCK, Seattle, WA (US); Natalia Larios DELGADO, Kirkland, WA (US)

(73) Assignee: Microsoft Technology Licensing, LLC, Redmond, WA (US)

(21) Appl. No.: 17/332,673

(22) Filed: May 27, 2021

(51) Int. Cl. G06F 16/435; G06F 16/45; G06F 16/483; G06N 20/00

(52) U.S. Cl. CPC G06F 16/437; G06F 16/45; G06F 16/483; G06N 20/00

(57) ABSTRACT

Examples of the present disclosure describe systems and methods for content-based multimedia retrieval with attention-enabled local focus. In aspects, a search query comprising multimedia content may be received by a search system. A first semantic embedding representation of the multimedia content may be generated. The first semantic embedding representation may be compared to a stored set of candidate semantic embedding representations of other multimedia content. Based on the comparison, one or more candidate representations that are visually similar to the first semantic embedding representation may be selected from the stored set of candidate semantic embedding representations. The candidate representations may be ranked, and top ‘N’ candidate representations (or corresponding multimedia items) may be retrieved and provided as search results for the search query.

### BACKGROUND

Many search systems enable users to use text-based searching techniques to search for content. While text-based searching may be useful to identify text-based content, such techniques are less effective when searching for images, videos, or multimedia content. Such techniques are also less effective for applications in domains where defining a text-based query (e.g., entering keywords or even complete sentences) is time consuming, difficult, or even impossible given the complexity of the description of the desired content or the user's lack of familiarity with the search content.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for content-based multimedia retrieval with attention-enabled local focus. In aspects, a search query comprising multimedia content may be received by a search system. A first semantic embedding representation of the multimedia content may be generated. The first semantic embedding representation may be compared to a stored set of candidate semantic embedding representations of other multimedia content. Based on the comparison, one or more candidate representations that are visually similar to the first semantic embedding representation may be selected from the stored set of candidate semantic embedding representations. The candidate representations may be ranked, and top ‘N’ candidate representations (or corresponding multimedia items) may be retrieved and provided as search results for the search query.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system for content-based multimedia retrieval with attention-enabled local focus.

FIG. 2 illustrates an example input processing system for cross-provider topic conflation.

FIG. 3 illustrates an example method for cross-provider topic conflation.

FIG. 4 is a block diagram illustrating example physical components of a computing device with which aspects of the disclosure may be practiced.

FIGS. 5A and 5B are simplified block diagrams of a mobile computing device with which aspects of the present disclosure may be practiced.

FIG. 6 is a simplified block diagram of a distributed computing system in which aspects of the present disclosure may be practiced.

FIG. 7 illustrates a tablet computing device for executing one or more aspects of the present disclosure.

### DETAILED DESCRIPTION

Many traditional search systems utilize a keyword-based analysis to provide search results for a search query. The keyword-based analysis may be used when a search query comprises text-based content or multimedia-based content. For text-based content, one or more keywords may be identified and/or extracted from the search query. For multimedia-based content, one or more keywords describing the multimedia-based content or associated with a category or topic of the multimedia-based content may be identified. The search system may use the identified keyword(s) to retrieve search results from one or more data sources. The relevance or accuracy of the search results may depend on the degree of similarity between the search query and the identified keyword(s). When the degree of similarity between the search query and the identified keyword(s) is high, the search results may comprise attributes that are similar to the attributes of the search query. However, when the degree of similarity between the search query and the identified keyword(s) is low, the search results may comprise attributes that differ in significant respects from the attributes of the search query. As a specific example, a search query comprising an image of a grey Chartreux cat may be received by a traditional search system. The search system may employ the keyword-based analysis to determine that the image is associated with the keyword “cat.” Based on the lack of specificity of the keyword (e.g., “cat” as opposed to “grey Chartreux cat”), the search results may comprise content for breeds and colors of cats that are different from the cat in the image.

To address such challenges with searching for multimedia content using text-based approaches, the present disclosure describes systems and methods for content-based multimedia retrieval with attention-enabled local focus. In aspects, a search query comprising multimedia content may be received by a content search and retrieval system. The multimedia content may represent one or more portions of multimedia content that have been marked (or otherwise designated) in a data source by a user. The marked portion(s) of multimedia content may represent localized areas of user focus or user attention. The system may implement a deep learning model that is trained to identify areas of focus/attention in multimedia content based on requested tasks. The system may use the deep learning model to generate a first semantic embedding representation (“query representation”) of the multimedia content. The query representation may represent the visual representation of the multimedia content or of one or more objects within the multimedia content. The system may access one or more data sources that store semantic embedding representation (“reference representations”) of multimedia content. The reference representations may also have been generated using the same deep learning model. The system may compare the query representation to the reference representations based on one or more distance metrics for the query representation and the reference representations. The reference representations may be ranked according to the distance metrics and one or more multimedia content items corresponding to the reference representations may be retrieved from the data source(s). The retrieved multimedia content items may be provided as search results for the search query.

The content-based multimedia retrieval approach described in the present disclosure provides several advantages over the traditional search systems described above. As one example, the keyword-based analysis of the traditional search systems requires the storage and synchronization of a representation of the multimedia content and the corresponding keyword space representation of the multimedia content. In contrast, the concept-based analysis of the present disclosure does not require the keyword space representation of the multimedia content. As such, the concept-based analysis of the present disclosure requires fewer storage and processing resources than the keyword-based analysis of the traditional search systems. As another example, the keyword-based analysis of the traditional search systems requires that a search term or phrase be entered to perform a search query for multimedia content. However, in many cases, a search term or phrase may not be known or may be inadequate to appropriately describe multimedia content. In contrast, the concept-based analysis of the present disclosure enables a user to select a multimedia item (or one or more portions thereof). The selected multimedia item is provided in the search query as an example of the desired search result. Search results are provided based on the visual representation of the multimedia item in search query, not on keywords. As such, the concept-based analysis of the present disclosure provides the optimal means to express a search query for multimedia content in many scenarios, such as those described above.

Accordingly, the present disclosure provides a plurality of technical benefits including but not limited to: improving the accuracy and relevance of search results for multimedia content; reducing the storage and processing requirements to search multimedia content; a deep learning model trained to (i) generate semantic embedding representations of multimedia content and/or other types of content, and/or (ii) identify areas of focus in multimedia content and/or semantic embedding representations of multimedia content; leveraging attention-enabled mechanisms to focus on relevant areas within multimedia content; and retrieving search results based on embedding representation information for an area within multimedia content (as opposed to using information for the entire multimedia content), among other examples.

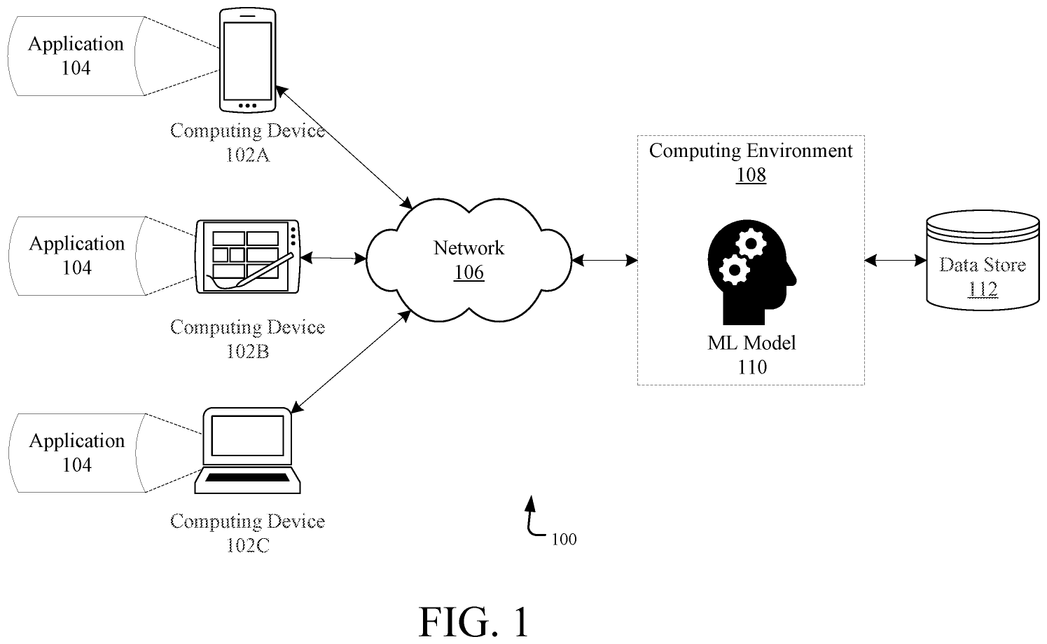

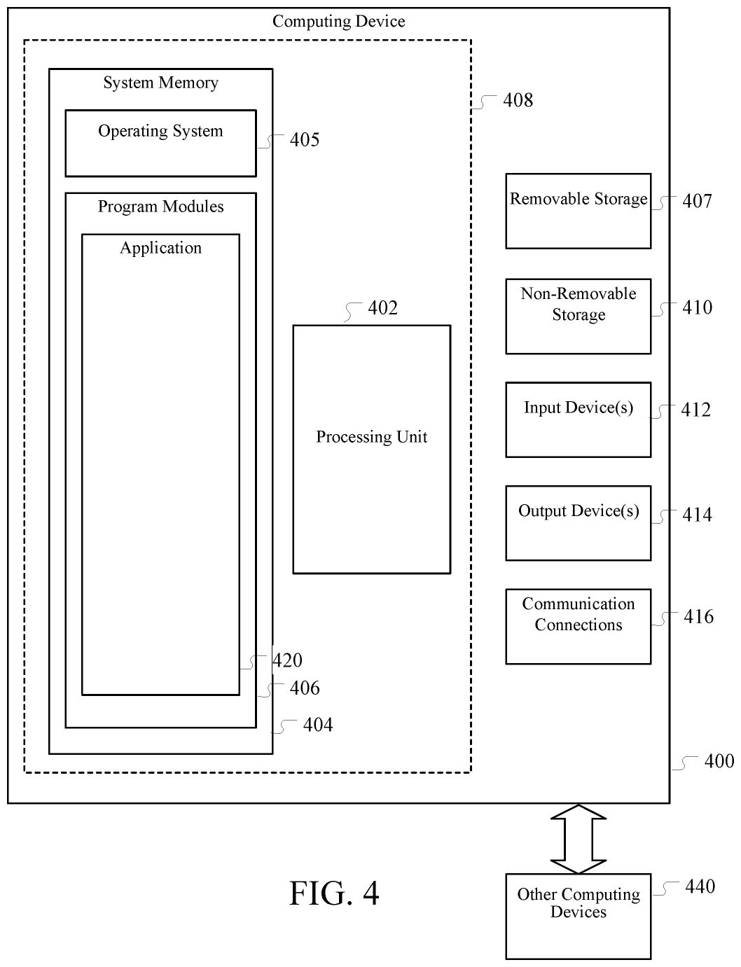

FIG. 1 illustrates an overview of an example system for content-based multimedia retrieval with attention-enabled local focus. Example system 100 as presented is a combination of interdependent components that interact to form an integrated whole. Components of system 100 may be hardware components or software components (e.g., applications, application programming interfaces (APIs), modules, virtual machines, or runtime libraries) implemented on and/or executed by hardware components of system 100. In one example, components of systems disclosed herein may be implemented on a single processing device. The processing device may provide an operating environment for software components to execute and utilize resources or facilities of such system. An example of one or more processing devices comprising such an operating environment is depicted in FIGS. 4-7. In another example, the components of systems disclosed herein may be distributed across multiple processing devices. For instance, input may be entered on a user device or client device and information may be processed on or accessed from other devices in a network, such as one or more remote cloud device or web server devices.

In FIG. 1, system 100 comprises user devices 102A, 102B, and 102C (collectively “user device(s) 102”), network 106, computing environment 108, and data store(s) 112. One of skill in the art will appreciate that the scale of systems such as system 100 may vary and may include additional or fewer components than those described in FIG. 1. As one example, system 100 may comprise additional computing environments 108, at least one of which may be at least partially implemented by user device(s) 102. As another example, one or more of data store(s) 112 may be integrated into computing environment 108.

User device(s) 102 may be configured to detect and/or collect input data from one or more users or devices. The input data may correspond to user interaction with one or more software applications or services implemented by, or accessible to, user device(s) 102. The input data may include, for example, voice input, touch input, text-based input, gesture input, video input, and/or image input. The input data may be detected/collected using one or more sensor components of user device(s) 102. Examples of sensors include microphones, touch-based sensors, geolocation sensors, accelerometers, optical/magnetic sensors, gyroscopes, keyboards, and pointing/selection tools. Examples of user device(s) 102 may include, but are not limited to, personal computers (PCs), mobile devices (e.g., smartphones, tablets, laptops, personal digital assistants (PDAs)), wearable devices (e.g., smart watches, smart eyewear, fitness trackers, smart clothing, body-mounted devices, head-mounted displays), and gaming consoles or devices.

User device(s) 102 may comprise or otherwise have access to application(s) 104. Application(s) 104 may enable users to access and/or interact with one or more types of content, such as text, audio, images, video, animation, and multimedia (e.g., a combination of text, audio, images, video, and/or animation). For instance, application(s) 104 may comprise or have access to a corpus of content sources (e.g., documents, files, applications, services, web content) including various types of content. Examples of application(s) 104 may include, but are not limited to, word processing applications, spreadsheet application, presentation applications, document-reader software, social media software/platforms, search engines, media software/platforms, multimedia player software, content design software/tools, and database applications.

In some examples, application(s) 104 may comprise or provide access to a content selection system for enabling a user to enter or select content to be searched using the search system. The content selection system may enable a user to enter a text-based search query into a search area, such as a text box, of the search system. In at least one example, the functionality may also enable a user to specify a search query that is not text-based. For instance, the content selection system may provide a mechanism that enables a user to mark (or otherwise designate) content in a content source. The marking may include selecting one or more areas, regions, or sections of content using freeform and/or structured content selection tools. The marked content may be provided as a search query to computing environment 108 via network 106. For instance, the content selection system may comprise a “Find Similar” button/option, a “Search for Selection” button/option, or a similar search initiation mechanism. Examples of network 106 may include a private area network (PAN), a local area network (LAN), a wide area network (WAN), and the like. Although network 104 is depicted as a single network, it is contemplated that network 106 may represent several networks of similar or varying types.

Computing environment 108 may be configured to receive and process search queries received from user device(s) 102 and/or other computing devices. In examples, computing environment 108 may comprise or represent one or more computing devices or services. Example computing devices or services may include server devices (e.g., web servers, file servers, application servers, database servers), cloud computing devices/services (e.g., Infrastructure as a Service (IaaS), Platform as a Service (PaaS), Software as a Service (SaaS), Functions as a Service (FaaS)), virtual devices, PCs, or the like. The computing devices may comprise one or more sensor components, as discussed with respect to user device(s) 102. In some examples, computing environment 108 may comprise or provide access to a search system for retrieving content and/or content sources. Examples of search systems include web search engines, content discovery services, database search engines, and similar content searching utilities.

Computing environment 108 may comprise or otherwise have access to machine learning model(s) 110. Computing environment 108 may provide received search queries (or content thereof) to machine learning model(s) 110 as input. Machine learning model(s) 110 may be trained to identify and evaluate indicated areas of user focus/attention in content of the search query. Machine learning model(s) 110 may output a semantic embedding representation of the areas of user focus/attention in the content of the search query. In some examples, machine learning model(s) 110 may use the semantic embedding representation to search data store(s) 112 for content similar to the content of the search query. In other examples, machine learning model(s) 110 provide the semantic embedding representation to the search system. The search system (or another component of computing environment 108) may use the semantic embedding representation to search data store(s) 112 for content similar to the content of the search query.

Data store(s) 112 may store content from one or more content sources. Data store(s) 112 may also or alternatively store one or more semantic embedding representations corresponding to the stored content. In aspects, the stored semantic embedding representations may be generated using machine learning model(s) 110. For example, a corpus of content stored in data store(s) 112 may be provided as input to machine learning model(s) 110. Machine learning model(s) 110 may output a set of semantic embedding representations. The set of semantic embedding representations may be correlated, linked, or otherwise associated with the corresponding content and stored accordingly. Examples of data store(s) 112 include, but are not limited to, databases, file systems, file directories, flat files, and virtualized storage systems.

In aspects, searching data store(s) 112 may comprise using machine learning model(s) 110 to calculate one or more distances (e.g., cosine similarity or Euclidean distance) between the semantic embedding representation for the received search query and one or more semantic embedding representations in data store(s) 112. Machine learning model(s) 110 may identify and rank one or more semantic embedding representations in data store(s) 112 based on the calculated distances. Machine learning model(s) 110 may select one or more semantic embedding representations (e.g., a top ‘N’ semantic embedding representations) from the ranked semantic embedding representations as result data. The content items corresponding to the result data may be retrieved from data store(s) 112. The retrieved content items may represent the content in data store(s) 112 that most closely matches the content of the search query. Computing environment 108 may then provide the retrieved content items to user device(s) 102 in response to the search query.

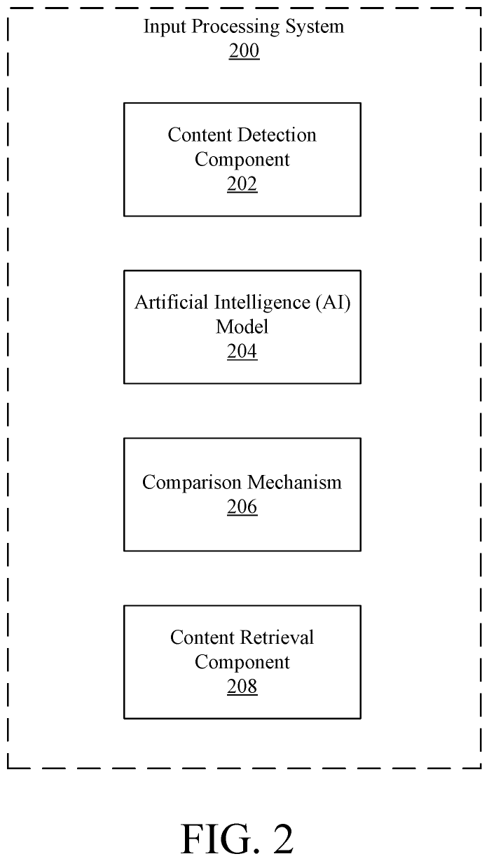

FIG. 2 illustrates an example input processing system for content-based multimedia retrieval with attention-enabled local focus. The techniques implemented by input processing system 200 may comprise the techniques and data described in system 100 of FIG. 1. Although examples in FIG. 2 and subsequent figures will be discussed in the context of multimedia content, the examples are equally applicable to other types of content, such as text content, image content, and video content. In some examples, one or more data and components described in FIG. 2 (or the functionality thereof) may be distributed across multiple devices. In other examples, a single device may comprise the data and components described in FIG. 2.

In FIG. 2, input processing system 200 comprises content detection component 202, artificial intelligence (AI) model(s) 204, comparison mechanism 206, and content retrieval component 208. One of skill in the art will appreciate that the scale of input processing system 200 may vary and may include additional or fewer components than those described in FIG. 2. As one example, the functionality of comparison mechanism 206 and/or content retrieval component 208 may be integrated into AI model(s) 204. As another example, input processing system 200 may additionally comprise one or more data stores that store multimedia content and/or semantic embedding representation of multimedia content.

Content detection component 202 may be configured to receive multimedia content. In aspects, content detection component 202 may comprise or implement a listener mechanism (e.g., function, a procedure, or a service) that monitors for the occurrence of one or more events. The events monitored by the listener mechanism may include, but are not limited to, the selection of a multimedia content item (or one or more portions thereof), the activation of a content selection utility, the receival of a search query, or the activation of an application or service. The listener mechanism may enable to content detection component 202 detect and/or receive multimedia content from one or more sources, such as user device(s) 102. In examples, the multimedia content may represent entire multimedia content items or portions thereof.

AI model(s) 204 may be configured to generate semantic embedding representations of multimedia content. A model, as used herein, may refer to a predictive or statistical utility or program that may be used to predict a response value from one or more predictors. A model may be based on, or incorporate, one or more rule sets, machine learning (ML), a neural network, or the like. Examples of AI model(s) 204 may include neural networks, decision tree algorithms, logistic regression algorithms, support vector machines (SVM) algorithms, k-nearest-neighbor (KNN) algorithms, Naïve Bayes classifiers, linear regression algorithms, and k-means clustering algorithms. As a specific example, AI model(s) 204 may be a deep learning model for evaluating visual similarity between multimedia content at the image-level and/or object-level.

In aspects, AI model(s) 204 may be trained using training data from one or more sources, such as user device(s) 102 and other computing devices. The training data may include labeled (or otherwise annotated) multimedia content and/or unlabeled multimedia content. The training data may be used to teach AI model(s) 204 to identify areas and/or topics of interest to a user in multimedia content. The areas and/or topics of interest may be specified (or otherwise indicated) by a user via supervised learning and may vary based on user intent, query type, or various other factors. For example, a user (or the training data) may indicate content (or types of content) that is considered to be similar to the training data, content that is considered to be dissimilar to the training data, and/or a region (or types of regions) to evaluate in multimedia content. In this way, the user may provide object detection supervised learning. The regions to evaluate may be indicated by highlighting, enclosures (e.g., bounding boxes, encircling), or similar annotations/markings. As another example, the user (or the training data) may indicate the importance or priority of various multimedia attributes, such as distance between objects, horizontal and/or vertical positioning of objects, relative position of objects to each other, size/scale of objects, object color(s) or color order, object shape or surroundings, etc.

The training data may also be used to teach AI model(s) 204 to create semantic embedding representations of the multimedia content or of the portions of the multimedia content of interest to the user. In examples, a semantic embedding representation may be a high-dimensional feature vector. The feature vector may be an n-dimensional vector of numerical features that represent the multimedia content. Instead of simply storing information about the multimedia content as a whole, the feature vector may store attributes for various objects in the multimedia content and store context information for the multimedia content and/or objects thereof. For instance, a feature vector may store coordinate of points in semantic space for a region/area of interest and an indication of the type of search (e.g., search for general objects, search for a specific object, search for object shapes) for which the feature vector may be used or may be most effective. In examples, a semantic embedding representation comprising multimedia content of interest to the user may be used to retrieve result data that is more relevant/accurate than result data retrieved using embedding representations of the entire multimedia content item.

In aspects, AI model(s) 204 may create semantic embedding representations for received multimedia content using components and/or the framework of an artificial neural network (ANN). As one example, the ANN may produce a set of low-dimensional features (or feature vectors). The set of low-dimensional features may be combined into a single set of features and a positional encoding may be applied to the single set of features. The positionally-encoded set of features may be provided to an encoder-decoder mechanism/framework for image embedding. The encoder-decoder mechanism/framework may produce outputs for multiple similarity losses combined with a loss for overlap of bounding box-prediction during training of AI model(s) 204. Examples of similarity losses include triplet, contrastive, and arc cosine. The outputs may be image-level embedding representation and/or one or more object-level embedding representations. The object-level embedding representations may each represent one or more objects in an indicated area of interest of received multimedia content. In some examples, one or more of the object-level embedding representations may be combined. For instance, each of the object-level embedding representations may be combined into a single image-level embedding representation. In other examples, the object-level embedding representations may not be combined and/or may be linked to a multimedia content item. In aspects, the outputs may be generated without converting the received multimedia content into textual descriptions, captions, or keywords.

Comparison mechanism 206 may be configured to compare multiple semantic embedding representations. In aspects, comparison mechanism 206 may receive or have access to the semantic embedding representation generated for the multimedia content received by content detection component 202 (“generated representation”). Comparison mechanism 206 may access one or more data stores, such as data store(s) 112, storing multimedia content from one or more content sources and/or storing corresponding semantic embedding representations of the multimedia content (“reference representations”). Comparison mechanism 206 may calculate the distance between the generated representation and one or more of the reference representations using a distance metric, such as cosine similarity or Euclidean distance. Based on the calculated distances, comparison mechanism 206 may sort/rank the reference representations. For example, the reference representations may be ranked such that the reference representation having the lowest calculated distance is ranked highest, the reference representation having the second lowest calculated distance is ranked second highest, and so on. Comparison mechanism 206 may select the top ‘N’ reference representations to be included in a set of result data.

Content retrieval component 208 may be configured to retrieve multimedia content associated with the received multimedia content. In aspects, content retrieval component 208 may identify multimedia content items in the data store that correspond to the top ‘N’ reference representations. For example, the top ‘N’ reference representations may be assigned respective identifiers in a data store comprising the top ‘N’ reference representations. The identifiers may correlate the reference representations to corresponding multimedia content items. Content retrieval component 208 may retrieve the corresponding multimedia content items from the data store. The retrieved multimedia content items may represent the multimedia content items having a high degree of semantic and/or visual similarity to the received multimedia content. Content retrieval component 208 may provide the retrieved multimedia content items to the sender of the received multimedia content.

Having described various systems that may be employed by the aspects disclosed herein, this disclosure will now describe one or more methods that may be performed by various aspects of the disclosure. In aspects, method 300 may be executed by a system, such as system 100 of FIG. 1 or input processing system 200 of FIG. 2. However, method 300 is not limited to such examples. In other aspects, method 300 may be performed by a single device or component that integrates the functionality of the components of system 100 and/or input processing system 200. In at least one aspect, method 300 may be performed by one or more components of a distributed network, such as a web service/distributed network service (e.g. cloud service).

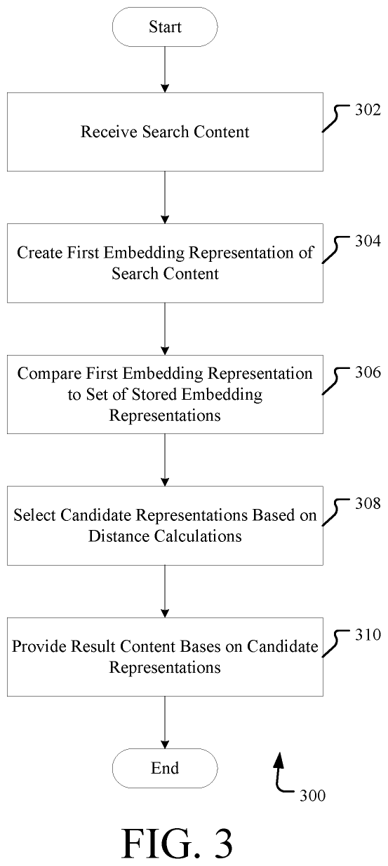

FIG. 3 illustrates an example method for content-based multimedia retrieval with attention-enabled local focus. Example method 300 begins at operation 302, where search content is received. In aspects, a search query from a computing device, such as user device(s) 102, may be received by an input receiving component, such as content detection component 202. The search query may comprise search content for which semantically and/or visually similar content is to be retrieved. The search content may comprise a multimedia content item or content selected from (or marked in) a multimedia content item (e.g., an image, an audio clip, a video). For example, the search content may correspond to an image in a document comprising text content, image content, and/or video content. The image may be selected or otherwise marked by a user viewing the document.

At operation 304, a semantic embedding representation may be created for the search content. In aspects, the search content may be provided to an AI model, such as AI model(s) 204. The AI model may be configured to identify and/or retrieve multimedia content that is similar to content specified in received search content. The indentation/retrieval of the multimedia content may comprise identifying areas, objects, and/or topics of interest to a user in multimedia content. The areas/topics of interest may be based on one or more marked (or otherwise selected) areas in the search content and/or in content used to train the AI model. For example, a user may select an area within an image. The AI model may determine that the selected area of the image is of interest to the user. The indentation/retrieval of the multimedia content may also comprise creating semantic embedding representations of the search content or of the portions of the search content of interest to the user. An embedding representation of the search content may store context information and content attributes for one or more objects in the search content. For example, an embedding representation may comprise feature information for an area/topic of interest within an image. In aspects, the semantic embedding representation is generated without converting the search content into textual descriptions, captions, or keyword.

At operation 306, the semantic embedding representation may be compared to a set of reference semantic embedding representations. In aspects, a distance calculation component, such as comparison mechanism 206 or the AI model, may receive or have access to the semantic embedding representation generated for the search (“generated representation”). The distance calculation component may also have access to one or more data stores storing multimedia content and/or semantic embedding representations of the multimedia content (“reference representations”). The distance calculation component may calculate the distance between the generated representation and one or more of the reference representations using a distance metric, such as cosine similarity or Euclidean distance. In one example, the Euclidean distance between the generated representation and each reference representation in the data store(s) may be calculated. In another example, the distance calculation component may calculate the distance between the generated representation and one or more types or categories of the reference representations. For instance, the generated representation may be compared to reference representations corresponding to images and/or videos. Alternatively, the generated representation may be compared to reference representations corresponding to a type of search query, such as a search for a type of brand/logo, a type of food, a type of animal, a type of object shape, etc.

At operation 308, a set of candidate representations may be selected from the reference representations. In aspects, the distance calculation component may sort and/or rank the reference representations based on the calculated distances. The sort order and/or rankings may indicate how closely the reference representations (or corresponding multimedia content) semantically or visually match the generated representation. For example, the reference representations for a first image, a second image, and a first frame of a video may be a Euclidean distance of 5.75, 25.15, and 12.30, respectively, from the generated representation. In another example, the reference representations for an image may be a Euclidean distance of 0.00 (or approximately 0.00) from the generated representation (indicating an exact match between search content and a multimedia item/object). Based on the distances, the first image may be ranked the highest (indicating the closest match to the generated representation), first frame of a video may be ranked the second highest, and the second image may be ranked the third highest. A top ‘N’ (e.g., one, three, ten) candidate representations may be selected from the reference representations based on the sort order and/or rankings. In some aspects, the candidate representations need not prominently display the search content or the areas and/or topics of interest to the user.

At operation 310, result content for the search content may be provided. In aspects, a content retrieval component, such as content retrieval component 208 or the AI model, may retrieve multimedia content corresponding to the selected candidate representations. The corresponding multimedia content may be retrieved from the data store(s) storing the reference representations and/or from additional data storage locations. An identifier (e.g., unique identifier, row number, hash ID) correlating the selected candidate representations to the corresponding multimedia content may be used to retrieve the corresponding multimedia content from the data store(s). For example, a selected candidate representation may comprise (or be associated with) a unique identifier. The unique identifier may be used to retrieve an image correlated to the selected candidate representation from a data store. In aspects, the retrieved multimedia content may be provided as result content for the search content. For instance, a first image, a first video (or frames therefrom), and a second image may be provided to the user device that provided the search query.

FIGS. 4-7 and the associated descriptions provide a discussion of a variety of operating environments in which aspects of the disclosure may be practiced. However, the devices and systems illustrated and discussed with respect to FIGS. 4-7 are for purposes of example and illustration and are not limiting of a vast number of computing device configurations that may be utilized for practicing aspects of the disclosure, described herein.

FIG. 4 is a block diagram illustrating physical components (e.g., hardware) of a computing device 400 with which aspects of the disclosure may be practiced. The computing device components described below may be suitable for the computing devices and systems described above. In a basic configuration, the computing device 400 may include at least one processing unit 402 and a system memory 404. Depending on the configuration and type of computing device, the system memory 404 may comprise, but is not limited to, volatile storage (e.g., random access memory), non-volatile storage (e.g., read-only memory), flash memory, or any combination of such memories.

The system memory 404 may include an operating system 405 and one or more program modules 406 suitable for running software application 420, such as one or more components supported by the systems described herein. The operating system 405, for example, may be suitable for controlling the operation of the computing device 400.

Furthermore, embodiments of the disclosure may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may also include additional data storage devices (removable and/or non-removable) such as, for example, magnetic disks, optical disks, or tape. Such additional storage is illustrated in FIG. 4 by a removable storage device 409 and a non-removable storage device 410.

As stated above, a number of program modules and data files may be stored in the system memory 404. While executing on the processing unit 402, the program modules 406 (e.g., application 420) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 400 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing device 400 may also have one or more input device(s) 412 such as a keyboard, a mouse, a pen, a sound or voice input device, a touch or swipe input device, etc. The output device(s) 414 such as a display, speakers, a printer, etc. may also be included. The aforementioned devices are examples and others may be used. The computing device 400 may include one or more communication connections 416 allowing communications with other computing devices 440. Examples of suitable communication connections 416 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

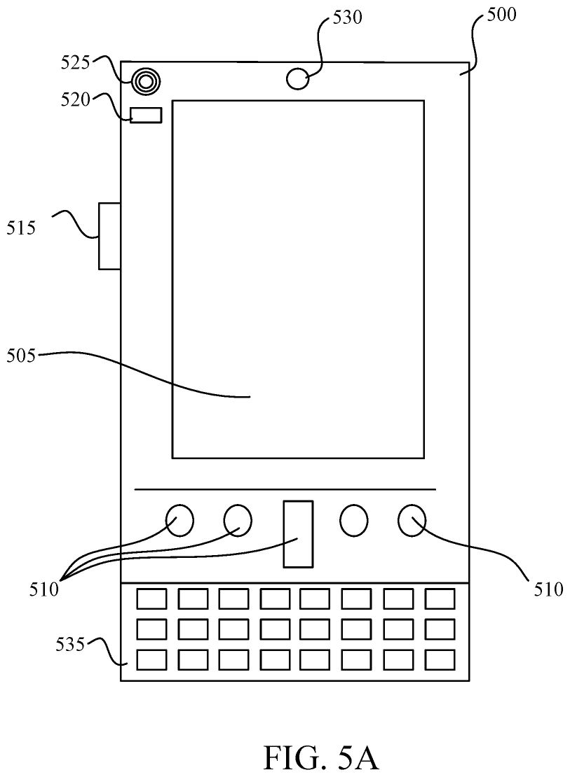

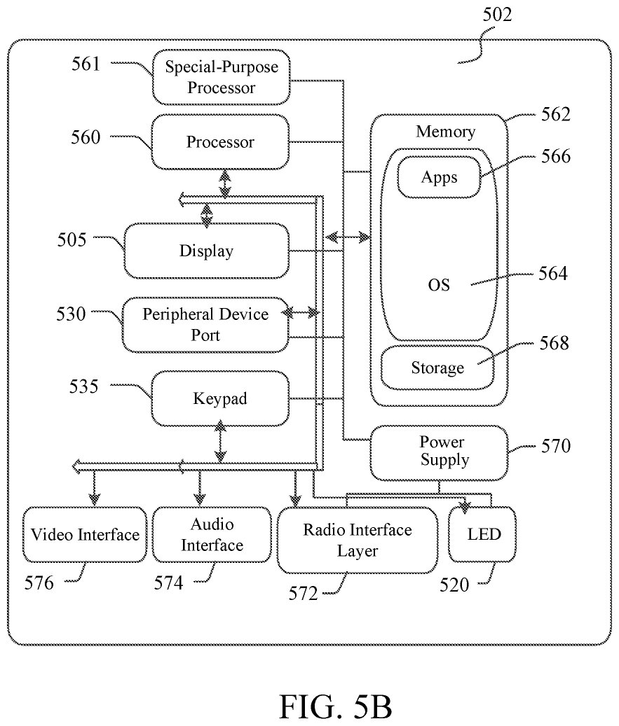

FIGS. 5A and 5B illustrate a mobile computing device 500, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 5A, one aspect of a mobile computing device 500 for implementing the aspects is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. The display 505 of the mobile computing device 500 may also function as an input device (e.g., a touch screen display).

If included, an optional side input element 515 allows further user input. The side input element 515 may be a rotary switch, a button, or any other type of manual input element. In alternative aspects, mobile computing device 500 may incorporate more or less input elements. For example, the display 505 may not be a touch screen in some embodiments.

In yet another alternative embodiment, the mobile computing device 500 is a portable phone system, such as a cellular phone. The mobile computing device 500 may also include an optional keypad 535. Optional keypad 535 may be a physical keypad or a “soft” keypad generated on the touch screen display.

In various embodiments, the output elements include the display 505 for showing a graphical user interface (GUI), a visual indicator 520 (e.g., a light emitting diode), and/or an audio transducer 525 (e.g., a speaker). In some aspects, the mobile computing device 500 incorporates a vibration transducer for providing the user with tactile feedback. In yet another aspect, the mobile computing device 500 incorporates input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one aspect of a mobile computing device. That is, the mobile computing device 500 can incorporate a system (e.g., an architecture) 502 to implement some aspects. In one embodiment, the system 502 is implemented as a “smart phone” capable of running one or more applications (e.g., browser, e-mail, calendaring, contact managers, messaging clients, games, and media clients/players). In some aspects, the system 502 is integrated as a computing device, such as an integrated personal digital assistant (PDA) and wireless phone.

One or more application programs 566 may be loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. The system 502 also includes a non-volatile storage area 568 within the memory 562. The non-volatile storage area 568 may be used to store persistent information that should not be lost if the system 502 is powered down. The application programs 566 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500 described herein (e.g., search engine, extractor module, relevancy ranking module, answer scoring module).

The system 502 has a power supply 570, which may be implemented as one or more batteries. The power supply 570 might further include an external power source, such as an AC adapter or a powered docking cradle that supplements or recharges the batteries.

The system 502 may also include a radio interface layer 572 that performs the function of transmitting and receiving radio frequency communications. The radio interface layer 572 facilitates wireless connectivity between the system 502 and the “outside world,” via a communications carrier or service provider. Transmissions to and from the radio interface layer 572 are conducted under control of the operating system 564. In other words, communications received by the radio interface layer 572 may be disseminated to the application programs 566 via the operating system 564, and vice versa.

The visual indicator 520 may be used to provide visual notifications, and/or an audio interface 574 may be used for producing audible notifications via the audio transducer 525. In the illustrated embodiment, the visual indicator 520 is a light emitting diode (LED) and the audio transducer 525 is a speaker. These devices may be directly coupled to the power supply 570 so that when activated, they remain on for a duration dictated by the notification mechanism even though the processor(s) (e.g., processor 560 and/or special-purpose processor 561) and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. In accordance with embodiments of the present disclosure, the microphone may also serve as an audio sensor to facilitate control of notifications, as will be described below. The system 502 may further include a video interface 576 that enables an operation of an on-board camera 530 to record still images, video stream, and the like.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated in FIG. 5B by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio interface layer 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio interface layer 572 or via a distributed computing network. Similarly, such data/information may be readily transferred between computing devices for storage and use according to well-known data/information transfer and storage means, including electronic mail and collaborative data/information sharing systems.

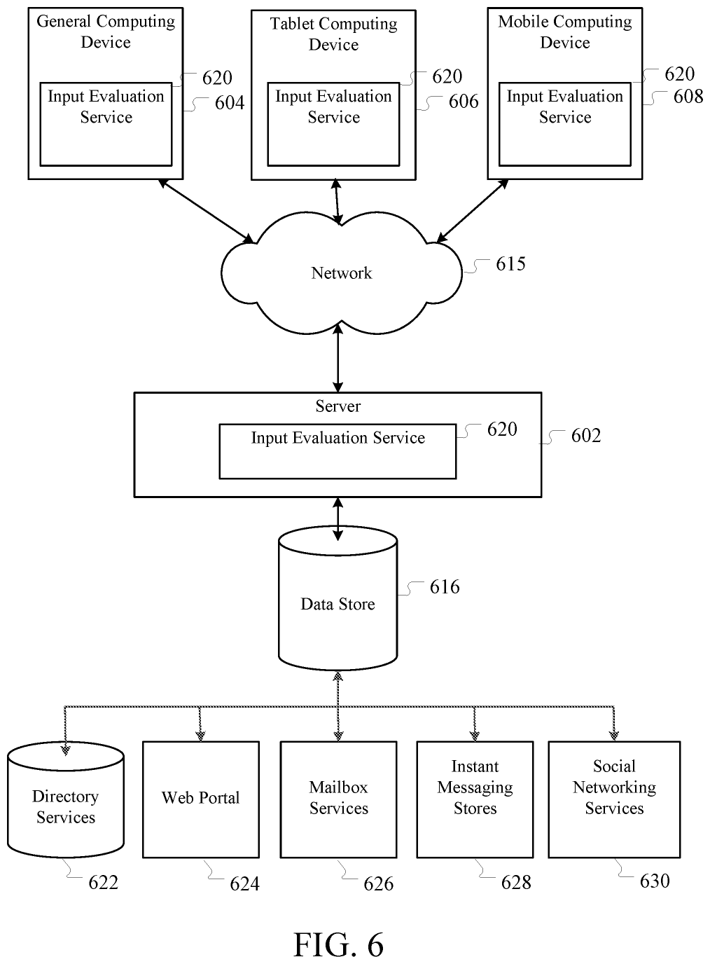

FIG. 6 illustrates one aspect of the architecture of a system for processing data received at a computing system from a remote source, such as a personal computer 604, tablet computing device 606, or mobile computing device 608, as described above. Content displayed at server device 602 may be stored in different communication channels or other storage types. For example, various documents may be stored using a directory service 622, a web portal 624, a mailbox service 626, an instant messaging store 628, or a social networking site 630.

An input evaluation service 620 may be employed by a client that communicates with server device 602, and/or input evaluation service 620 may be employed by server device 602. The server device 602 may provide data to and from a client computing device such as a personal computer 604, a tablet computing device 606 and/or a mobile computing device 608 (e.g., a smart phone) through a network 615. By way of example, the computer system described above may be embodied in a personal computer 604, a tablet computing device 606 and/or a mobile computing device 608 (e.g., a smart phone). Any of these embodiments of the computing devices may obtain content from the store 616, in addition to receiving graphical data useable to be either pre-processed at a graphic-originating system, or post-processed at a receiving computing system.

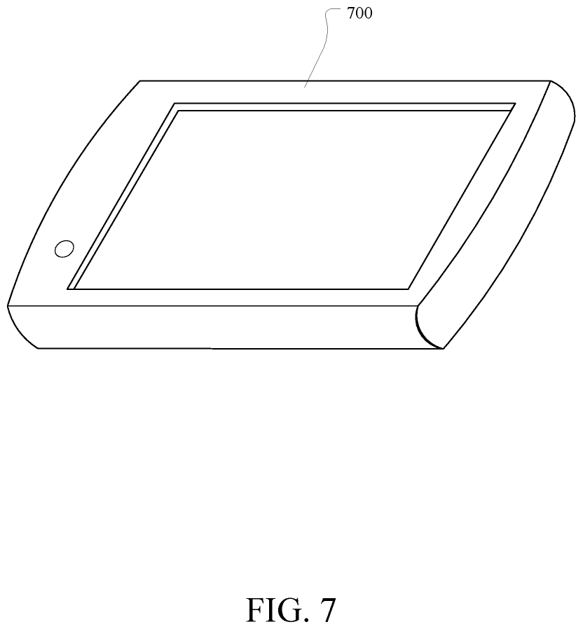

FIG. 7 illustrates an exemplary tablet computing device 700 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
a processor; and
memory coupled to the processor, the memory comprising computer executable instructions that, when executed by the processor, performs a method comprising:
receiving search content comprising one or more selected areas;
creating a first embedding representation for the search content based on one or more selected areas;
comparing the first embedding representation to a set of stored embedding representations based on distance calculations between the first embedding representation and each of the stored embedding representations;
selecting one or more candidate representations from the stored embedding representations based on the distance calculations; and
providing result content from the search content.

2. The system of claim 1, wherein:
the search content is collected from multimedia content; and
one or more selected areas comprise one or more objects in the multimedia content.

3. The system of claim 1, wherein creating the first embedding representation comprises providing the search content to an artificial intelligence model.

4. The system of claim 3, wherein the artificial intelligence model:
identifies one or more areas of interest to a user based on one or more selected areas; and
creates the first embedding representation to represent one or more areas of interest to the user.

5. The system of claim 4, wherein the artificial intelligence model is a deep learning model for evaluating visual similarity between multimedia content at an object-level.

6. The system of claim 5, wherein the deep learning model is trained with a multitask approach for learning image similarity using supervised detection learning.

7. The system of claim 1, wherein the first embedding representation stores sematic space information for the search content and context information for the search content.

8. The system of claim 1, wherein the first embedding representation is created without converting the search content into textual descriptions, captions, or keywords.

9. The system of claim 1, wherein the distance calculations are determined using cosine similarity or Euclidean distance.

10. The system of claim 1, wherein the set of stored embedding representations corresponds to multimedia content, the multimedia content comprising at least one of: text, images, audio, and video.

11. The system of claim 1, wherein selecting the one or more candidate representations comprises:
ranking the set of stored embedding representations based on the distance calculations; and
selecting a top ‘N’ of the set of stored embedding representations as the one or more candidate representations.

12. The system of claim 1, wherein:
the set of stored embedding representations are stored in a data store; and
selecting one or more candidate representations further comprises:
selecting a content item corresponding to each of the one or more candidate representations from the data store; and
providing each of the selected content items as the result data.

13. The system of claim 1, wherein:
the distance calculations are ranked in ascending order; and
the highest-ranking distance calculation indicates the highest degree of similarity between the first embedding representation and a second embedding representation in the set of stored embedding representations.

14. The system of claim 13, wherein the highest degree of similarity represents at least one of a visual similarity and/or a semantic similarity.

15. A method comprising:
receiving, by a first device, search content comprising one or more selected areas of multimedia content, wherein the one or more selected areas are selected by a user of a second device;
creating, using a deep learning model, an embedding representation for the search content based on the one or more selected areas;
comparing the embedding representation to a set of stored embedding representations based on distance calculations between the embedding representation and the stored embedding representations;
selecting one or more candidate representations from the set of stored embedding representations based on the distance calculations; and
providing result content corresponding to one or more candidate representations to the second device as a response to the search content.

16. The method of claim 15, wherein the deep learning model is used to retrieve content items that are visually or semantically similar to the search content.

17. The method of claim 15, wherein the embedding representation represents one or more objects in one or more selected areas.

18. The method of claim 15, wherein the embedding representation is created using an encoder-decoder mechanism for image embedding, the encoder-decoder mechanism being trained using one or more similarity loss metrics.

19. The method of claim 15, wherein a first content item in the result content is a different multimedia type from a second content item in the result content.

20. A first device comprising:
a processor; and
memory coupled to the processor, the memory comprising computer executable instructions that, when executed by the processor, performs a method comprising:
receiving search content comprising one or more selected areas of multimedia content, wherein one or more selected areas are selected by a user of a second device;
creating, using a deep learning model, a first semantic embedding representation for one or more selected areas;
comparing the first semantic embedding representation to a set of stored semantic embedding representations based on distance calculations between the first semantic embedding representation and the stored semantic embedding representations;
selecting one or more candidate representations from the set of stored semantic embedding representations based on the distance calculations; and
providing result content corresponding to one or more candidate representations to the second device as a response to the search content.
